(19) United States
(12) Patent Application Publication
(10) Pub. No.: US 2015/0219536 A1
(43) Pub. Date: Aug. 6, 2015

(54) SAMPLE PREPARATION AND TESTING SYSTEM

(71) Applicant: Dräger Safety AG & Co. KGaA, Lubeck (DE)

(72) Inventors: Matthias HODER, Lubeck (DE); Jessika MAHN, Ahrensbok/Dunkelsdorf (DE); Rainer POLZIUS, Lubeck (DE); Thomas WUSKE, Malente (DE)

(21) Appl. No.: 14/610,268

(22) Filed: Jan. 30, 2015

(30) Foreign Application Priority Data
Feb. 1, 2014 (DE) 10 2014 001 386.3

(51) Int. Cl. G01N 1/38

(52) U.S. Cl. CPC G01N 1/38; G01N 2001/386

(57) ABSTRACT

A sample preparation and testing system (10) includes a mixing container (1, 18). A display element (2, 40, 58, 60), functioning as a shaking indicator, is located in the interior of the mixing container (1, 18).

### CROSS REFERENCE TO RELATED APPLICATIONS

This application claims the benefit of priority under 35 U.S.C. §119 of German Patent Application DE 10 2014 001 386.3 filed Feb. 1, 2014, the entire contents of which are incorporated herein by reference.

### FIELD OF THE INVENTION

The present invention pertains to a sample preparation and testing system, sometimes designated below also only just as testing device, for the rapid uptake, stocking and discharge of samples, in particular liquid samples. The present invention pertains, moreover, to a method for using the testing device.

### BACKGROUND OF THE INVENTION

In diagnostics, the preparation of a respective sample represents an essential first step, which has a decisive effect on the precision and accuracy of the analysis. The sample preparation typically consists of the dilution of a liquid sample with a dilution fluid and then mixing with the reagents necessary for the analysis. In case of a solid sample, this is extracted by means of the dilution fluid. Dilution and extraction processes are usually provided by mechanical agitation, which, in the case of laboratory apparatuses, is carried out by electromechanical shakers or agitators (The Immunoassay Handbook, 3rd edition, D. Wild, 2005) and in the case of rapid diagnostic systems, either represents an intrinsic function of the testing system (e.g., in immunochromatographic testing systems) or is achieved by a manual shaking process.

A diagnostic device that combines an immunochromatographic test strip and a sampling system for house dust in a microfluidic system is known from DE 199 09 891. The house dust sample is collected in a porous sampling tip, then extracted by applying a dilution fluid by dropping, and the reagent dilution reactions represent an intrinsic function of the microfluidic system here. The sometimes low extraction accuracy of the process is still not optimal in this process.

A diagnostic testing system, which incorporates various reaction chambers, depots for dilution fluids and reagents, as well as a plurality of immunochromatographic test strips, emerges from U.S. Pat. No. 7,713,475. As a consequence of using the device, the liquid sample as well as dry reagents are mixed with dilution fluid. The patent does not contain any information about the manner of the mixing process.

A diagnostic device that has a mixing chamber with a depot for dry reagent in fluidic connection with an immunochromatographic test strip is known from EP 2 139 601 A. After charging in the liquid sample, the reagent is mixed with the liquid sample by manual agitation. The reaction mixture is then fed to the immunochromatographic test strip by opening a fluid connection. It emerges from the patent that the reagent may be gold conjugate, which is arranged on the bottom of the mixing chamber and is dissolved by manual shaking of the mixing chamber. The patent does not contain any information about how the shaking process is controlled over time.

### SUMMARY OF THE INVENTION

One object of the present invention is to provide a testing device, in which the user can recognize in a simple manner a necessary or sufficient duration of a shaking process. Moreover, one object of the present invention is to provide a special embodiment of a testing device as well as a method for the use of such a testing device.

This object is accomplished according to the present invention with a testing device having a display element located in the interior of the mixing container and functioning as a shaking indicator, which becomes discolored in the course of the shaking process and is completely discolored when dilution and/or extraction of the sample is completed entirely or to a sufficient extent and the shaking process can thus be ended, is provided in a testing device with a mixing container.

In the use of such a testing device, the mixing container with a sample provided in the mixing container is shaken until discoloration of the display element occurs.

The advantage of the present invention is that the user can determine the necessary or sufficient duration of a shaking process based on a change in color of a porous display element located in the mixing container. In this way, it is functionally guaranteed that the dilution and extraction processes in the mixing container proceed precisely and completely, such that a high analytical accuracy of a subsequent analysis method is guaranteed.

In one embodiment of the testing device, provisions are made for this testing device to comprise a sampler, an extractor and a starter, for the sampler to be combinable with the extractor and the extractor to be combinable with the starter, for example, by fitting together, and for a mixing container functioning as a shaking reactor and being sufficiently tight for a shaking process to form by combining the sampler with the extractor. The testing device thus consists of few, easy-to-use single components, and the mixing container forms by joining together two single components.

In EP 2 139 601 A the mixing chamber there is closed by means of a fold-down cover. Thus, the mixing chamber does not arise due to a combination of a sampler with another part of the testing device, which is different from the objective testing device. In US 2006/127274 A, a cup-like container, which is likewise not closed by means of a sampler but rather by means of a cover, functions as a mixing container. From WO 2005/045408 is known a device, in which a sponge-like sampler is inserted into a first, not hermetically sealed chamber and is pressed out there. At the same time, a reagent ampule is destroyed via a displaceable mandrel, such that a mixture of sample and reagent forms, which drops directly through local openings into a second chamber, in which further dry reagents are dissolved by the penetrating liquid. In this case as well, a sealed mixing container does not arise with the insertion of the sampler. The chamber is also not intended for shaking at all, because the mixture drops out of this chamber into a second chamber which is also not sufficiently tight for a shaking process, because, on the one hand, the second chamber opens into the first chamber and, on the other hand, the second chamber has openings for inserting test strips.

In the testing device with the sampler, extractor and starter, a porous display element of the type described above is not necessarily present in the mixing container arising due to the combination of sampler and extractor. Such a display element is, however, optionally present in the mixing container, and the following description is also continued using the example of a testing device with sampler, extractor and starter, comprising such a display element, but without waiving a continuing general validity.

In a special embodiment of the testing device, provisions are made for the sampler to have a sampling body at one end, for the sampler with the sampling body to be insertable into a tube of the extractor and to be inserted when using the testing device, and for an overpressure to form in the interior of the thus formed shaking reactor when the sampler is inserted into the extractor. The overpressure thus obtained is helpful when drawing the sample mixture out of the shaking reactor.

In the use of such a testing device, a sample is taken with the sampler, and the sampler is then combined with the extractor, such that the sampler and extractor together form a shaking reactor. The shaking reactor is then shaken until discoloration of the display element occurs, and a then resulting sample mixture may easily flow out of the shaking reactor because of an overpressure generated by combining the sampler and the extractor, when this shaking reactor is opened as intended, for example, by the shaking reactor being combined with the starter and being pushed into the starter for the analysis of the sample mixture.

An exemplary embodiment of the present invention is explained in detail below on the basis of the drawings. Subjects or elements corresponding to one another are provided with identical reference numbers in all figures.

The or each exemplary embodiment is not to be considered to be a limitation of the present invention. Rather, variations and modifications are possible within the framework of the present disclosure, especially such variants and combinations which can be inferred by the person skilled in the art, for example, by combining or modifying individual features or elements or process steps described in conjunction with the general or special section of the specification as well as contained in the claims and/or drawings with respect to accomplishing the object and by features that can be combined into a new subject or into new process steps or sequences of process steps, also insofar as they concern test and work processes.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

FIG. 1 is a schematic view showing a testing device according to the present invention with a display element for the visual checking of liquid-liquid mixing reactions or liquid-solid extraction reactions;

FIG. 2 is a schematic view showing a testing device as in FIG. 1 with a ring-shaped display element;

FIG. 3A is a schematic view showing a testing device as in FIG. 1 with further details;

FIG. 3B is a schematic view showing a testing device as in FIG. 1 with further details;

FIG. 4 is a perspective exploded view showing special embodiment of a testing device according to FIG. 2 with a sampler, an extractor and a starter;

FIG. 5 is a perspective view showing a shaking reactor formed by combining the sampler with the extractor;

FIG. 6 is a perspective exploded view showing the sampler;

FIG. 7 is a perspective view showing the extractor;

FIG. 8 is a perspective view showing the extractor;

FIG. 9 is a perspective view showing the extractor;

FIG. 10 is a perspective view showing the starter;

FIG. 11 is a perspective transparent view showing the starter;

FIG. 12 is a perspective longitudinal sectional view showing the testing device according to FIG. 4;

FIG. 13 is a perspective view showing another embodiment of the starter;

FIG. 14 is a perspective partially sectional view showing another embodiment of the starter;

FIG. 15 is a perspective exploded view showing a testing device according to FIG. 4 with a starter according to FIGS. 13, 14;

FIG. 16 is a perspective partially sectional exploded view showing a testing device according to FIG. 4 with a starter according to FIGS. 13, 14;

FIG. 17 is a perspective view showing a testing device according to FIG. 4 with another embodiment of a starter;

FIG. 18 is a partially cutaway perspective view showing the device of FIG. 17; and

FIG. 19 is a partially cutaway perspective view showing the device of FIG. 17;

### DESCRIPTION OF THE PREFERRED EMBODIMENTS

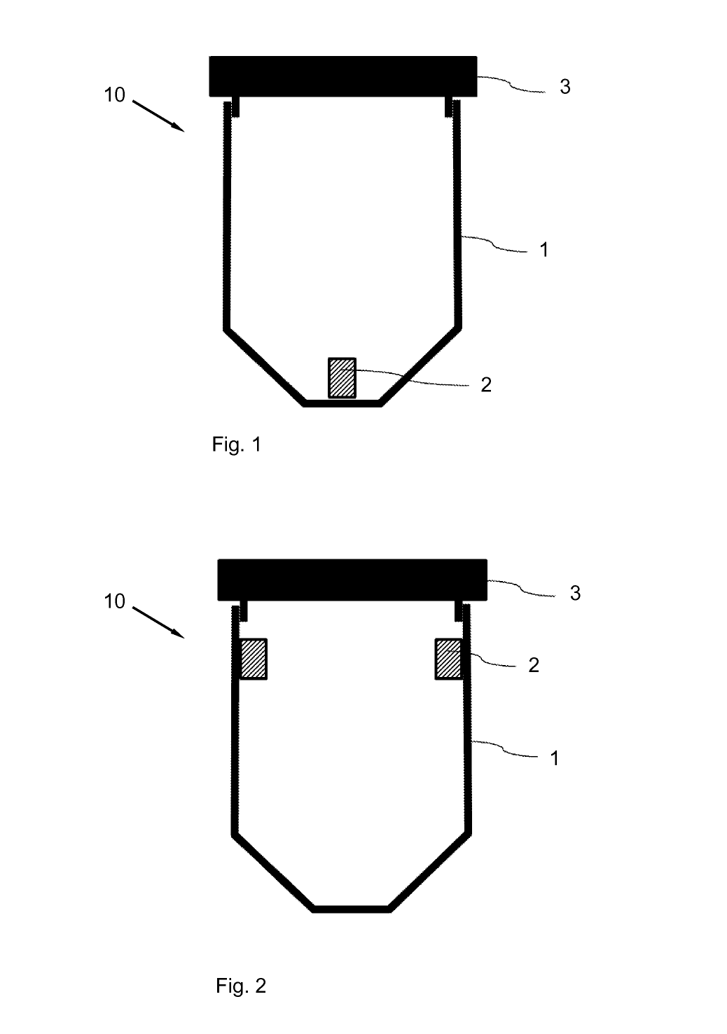

Referring to the drawings, the view in FIG. 1 shows in a schematically simplified way a testing device 10 as an example for a device for the visual checking of liquid-liquid mixing reactions or liquid-solid extraction reactions in a mixing container 1 by means of a porous display element 2, which contains a dye in dry form and is recognizable through a wall or a wall section of the mixing container 1. A cover 3 for opening the mixing container 1 as well as for the tight closing of the mixing container 1 is assigned to the mixing container 1.

In the embodiment of the testing device 10 shown in FIG. 1, the display element 2 is inserted freely movable into the mixing container 1. In the embodiment of the testing device 10 shown in FIG. 2, the display element 2 is attached to the wall of the mixing container 1, such that it is visible for use through a wall of the mixing container 1 that is transparent at least in this area and can be visually analyzed by the user.

The porous display element 2 is impregnated with a dye, which is discharged from the porous display element 2 as a result of a mechanical agitation of a liquid located in the mixing container 1, especially a liquid in the form of a liquid sample or a liquid sample mixture, for example, by shaking the mixing container 1, and is dissolved in the liquid. The discoloration reaction of the porous display element 2 is visually recognizable by the user and defines the end of the mixing reaction or extraction reaction (completion of the shaking process).

The porous display element 2 is comprised of a material with preferably defined pore diameters and pore volumes. The pore sizes are between 1,000 μm and 1 μm. Pore sizes between 200 μm and 10 μm have proven to be especially advantageous. The porous display element 2 is impregnated with a water-soluble dye, which is present and is distributed in the dry form in the pores thereof.

In a special embodiment of the testing device 10, the dye in the porous display element 2 is at the same time a reagent, which is needed in a subsequent detection reaction after dissolving in the liquid and mixing with a sample to be analyzed for diagnostic purposes. In the case of using immunochromatographic test strips, a particle-antibody conjugate, for example, may be used as a reagent. In this case, the use of additional dyes can also be entirely dispensed with partly due to the inherent coloring of the particle-antibody conjugate.

The shape of the three-dimensional porous display element 2 may be, for example, spherical, square, cylindrical or ring-shaped. All porous materials are possible as material, i.e., for example, such fibrous materials as polyester or cellulose, foams or sintered materials. Sintered materials, for example, metal sinter or plastic sinter, have proven to be especially advantageous. The latter make it possible to produce a precisely defined shape of the porous display element 2 with defined pore size. In addition, sintered elements are largely inherently stable and may, if necessary, be fixed by press fit, for example, in the mixing container 1, as this is shown in the upper area of the view in FIG. 2. The shape and pore size of the porous display element 2 are decisive for the correct display of the shaking time. The shape and pore size of the porous display element 2 represent parameters to adjust the display accurately and to coordinate with the dilution and extraction processes. In this case, the shaking time increases with decreasing pore size and increasing volume of the porous display element 2.

In a use of the testing device according to FIG. 1 or FIG. 2, after opening the cover 3, a liquid or solid sample is provided by the user in the mixing container 1. In addition, the addition of a dilution fluid in the mixing container 1 is also possible, when the liquid sample shall be diluted or a solid sample shall be extracted. After closing the cover 3, the mixing container 1 is shaken by the user, such that the dilution and/or extraction process can take place. At the same time, the dye is flushed out of the porous display element 2 due to the shaking process. The discoloration of the porous display element 2 can be observed by the user through the transparent wall of the mixing container 1. A discolored porous display element 2 shows the user that the shaking process is finished. The extracted or diluted sample can in this case be removed from the mixing container 1 and fed to an analysis system, for example, an immunochromatographic test strip.

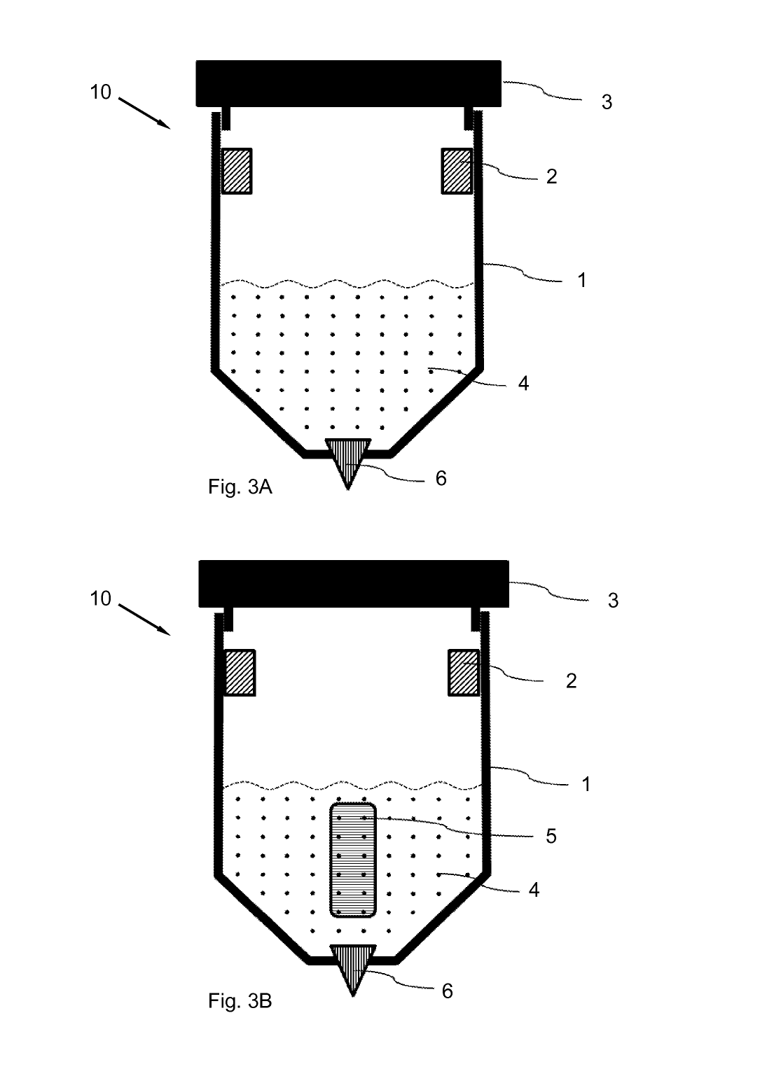

The two views in FIG. 3A and FIG. 3B show a special embodiment of the testing device 10 according to FIG. 2. In this case as well, the porous display element 2 is attached to the wall of the mixing container 1. A ring-shaped display element 2, which is fixed, for example, by press fit to the wall of the mixing container 1, is suitable for this. The porous display element 2 is preferably positioned within the mixing container 1, such that after charging in the liquid sample and/or the dilution fluid 4 (FIG. 3A) or after charging in the dilution fluid 4 and a solid sample 5 (FIG. 3B) in the preferred position of the mixing container 1, at first no wetting of the porous display element 2 by the liquid 4 takes place. The porous display element 2 is first brought into contact with the liquid 4 by manual shaking of the mixing container 1, and the dye is flushed out of the display element 2. The starting points of the color reaction in the porous display element 2 and the dilution or extraction reaction are synchronized in this way, such that the accuracy of the display is guaranteed.

The user is able to visually readily follow the change in color partly due to the wall contact of the porous display element 2 with the mixing container 1 which is transparent at least in this area.

After the color reaction has taken place, the extracted or diluted sample mixture of the mixing container 1 can be removed via the opening of the cover 3 and be fed to an analysis system, for example, an immunochromatographic test strip. In a special embodiment, the mixing container 1 has for this an outlet 6, which is in fluid contact with the analysis system or can be brought into fluid contact with such a system.

One special advantage of the testing device 10 and of a method carried out during its use is that dilution and extraction reactions, which are achieved by manual shaking, proceed completely and precisely. The display can be coordinated with the dilution or extraction processes partly due to the functionality and adjustability of the porous display element 2 as well as the positioning in the mixing container 1. Production and mounting of the porous display element 2 can be done in a precise and cost-effective manner as production goods in dipping and impregnating processes.

A special embodiment of a testing device 10 is given below. In this testing device 10, the above-described targeted discoloration of a porous display element 2 is utilized to increase operating safety by recognizability at any time of a completed or at least sufficient dilution or extraction reaction.

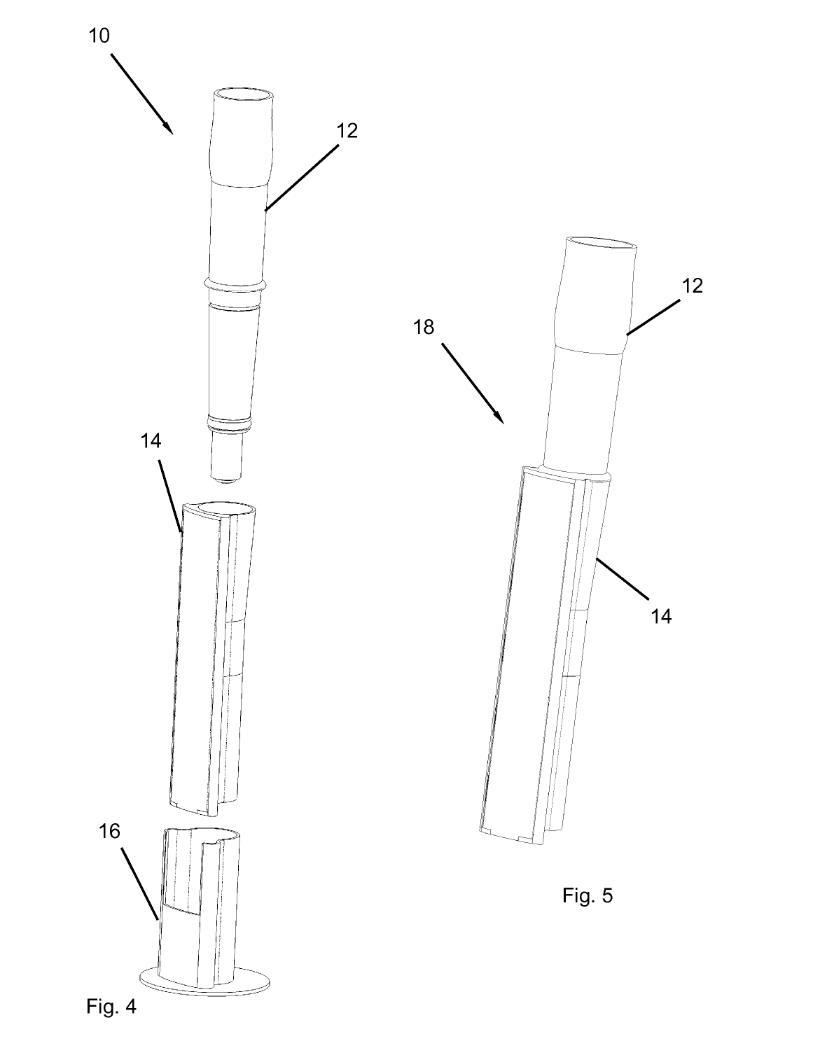

FIG. 4 shows in a schematically simplified view a special embodiment of a testing device 10 according to the present invention for biological liquids, which is also designated below as a test kit 10 and only for distinction from the general embodiment of the testing device 10 in FIG. 1 through FIGS. 3A, 3B.

The test kit 10 comprises a sampler 12, an extractor 14 and a starter 16. Due to the sequential combining of these three components of the test kit 10, which are geometrically complementary to one another, the desired improved integration of functions described in the introduction, a reduction in the number of work steps needed within the framework of a test process, as well as an improvement in operating safety are accomplished.

The view in FIG. 5 shows, in this respect, a hermetically sealed new reaction chamber, which is formed by combining, especially combining in the form of fitting together, the sampler 12 with the extractor 14, which is designated below as a shaking reactor 18 and which functionally corresponds to the mixing container 1 of the testing device 10, and therefore thus represents an example of a mixing container 1. The shaking reactor 18 and the starter 16 form the activated test kit 10 in the combined configuration. The central components 12, 14, 16 of the test kit 10 take charge of both functions taken alone by themselves and a plurality of communicating (interacting) functions in interaction with a respective complementary component.

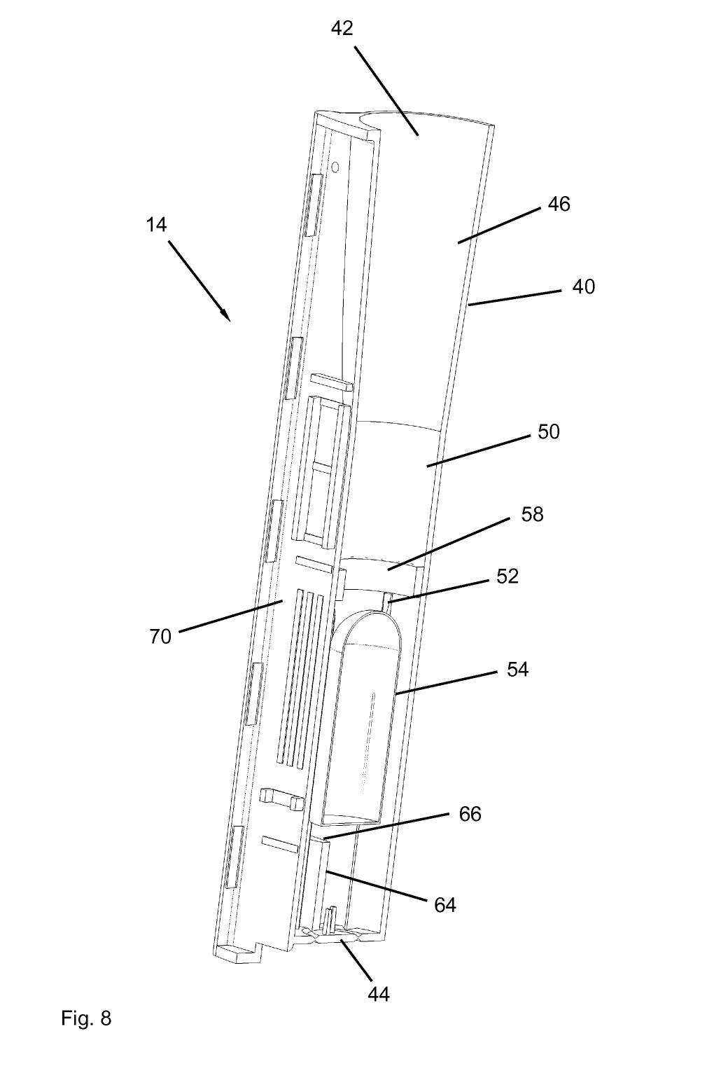

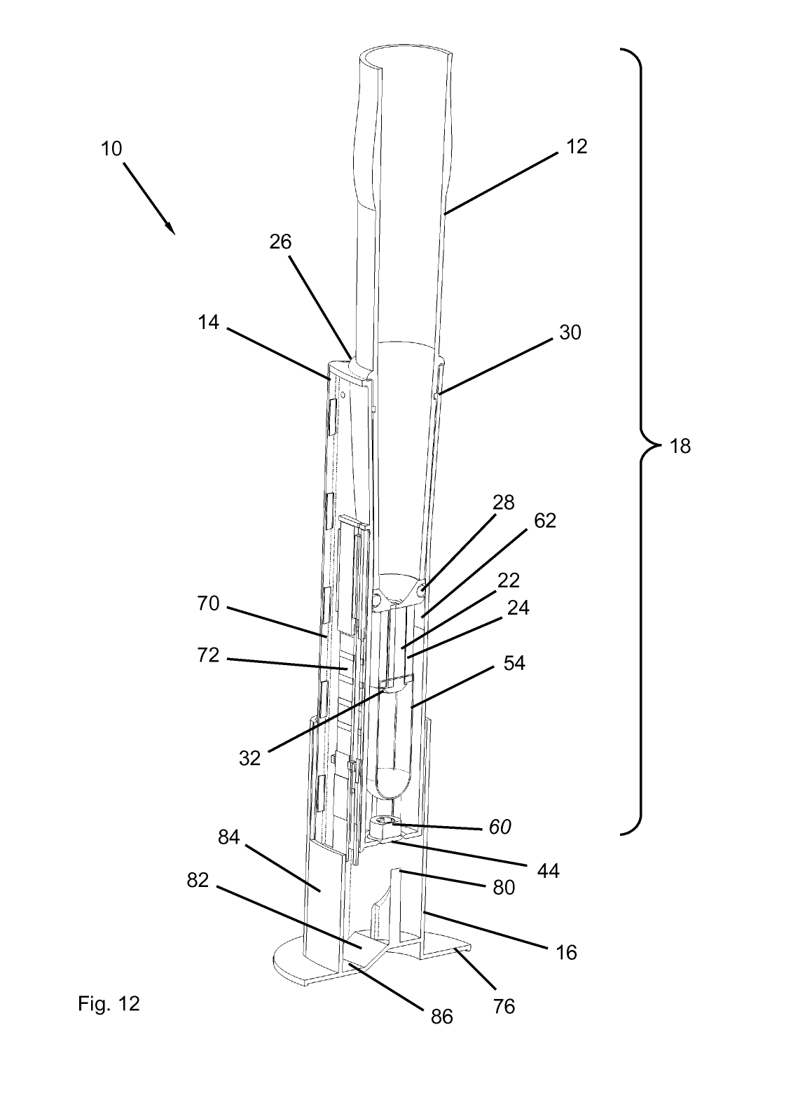

The test kit 10 makes possible the position-independent combining of an original sample at the sampler 12 with dry reagents (FIG. 8: Reagent carrier 58, FIG. 12: reagent carrier 60) and initially encapsulated as well as firmly deposited liquid reagents (FIG. 8: Liquid reagent depot 54) in a chamber formed in the interior of the shaking reactor 18. When combining the sampler 12 with the extractor 14, an overpressure forms in this chamber. The extracting, separation or dissolving of the original sample from the sampler 12 and the mixing or dilution of the sample with dry and/or wet reagents by shaking takes place in a subsequent manual work step in the same chamber. The result of the shaking process is designated below as reaction mixture or just as mixture. A completion of the shaking process can be displayed by a color indication of the type described in the introduction.

The individual components 12, 14 16 of the test kit 10 are explained in detail below:

### A. Sampler 12

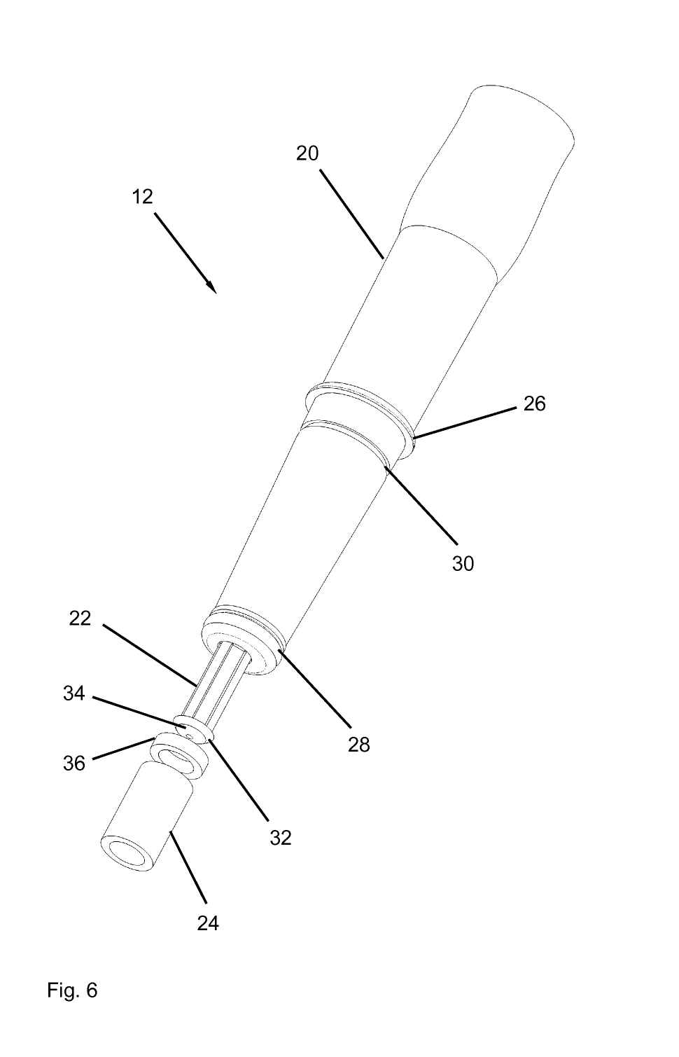

The view in FIG. 6 shows the sampler 12 in enlarged form and with further details. According to this, the sampler 12 is designed as a handle 20 at its one end and as a mounting pin 22 for a sampling body at its other end. In the embodiment shown, the sampler 12 comprises a circumferential border 26, a cone- or truncated-cone-shaped position-securing contour 32 for a sampling body 24 attached to the mounting pin 22, a circumferential sealing lip 28 as well as a circumferential groove or bead 30 for a positive-locking snapping in a corresponding contour in the extractor 14. In addition, the position-securing contour 32 is designed as a perforation tip, or a separate perforation tip 34 is located connected to the position-securing contour 32.

The sampler 12 functions as a carrier for a sleeve-like (hollow-cylindrical) sampling body 24 and optionally a ring-shaped indicator ring 36. The indicator ring 36 may—as shown—be attached in front of the sampling body 24 to the mounting pin 22 or connected to the sampling body 24 to the mounting pin 24. In both cases, the indicator ring 36 is in direct contact with the sampling body 24, and both the sampling body 24 and the indicator ring 36 are microporous, thin-walled, intrinsically stable and hydrophilic. The sintering of thermoplastic particles especially comes into consideration for producing such sampling bodies 24 and indicator rings 36. The indicator ring 36 is dyed in the unused state. Its discoloration takes place in the form of a flushing out of the deposited dye, for example, in the mouth of the test subject by the saliva.

In a special embodiment of sampler 12, the sampling body 24 is freely rotatable on the mounting pin 22 over a submillimeter gap. The precision of the contours of the mounting pin 22 and of the sampling body 24 needed for this as well as suitable material deformation properties for positive-locking components and components sliding on one another are known to the person skilled in the art and are achieved, for example, by current injection molding processes using thermoplastic polymers.

### B. Extractor 14

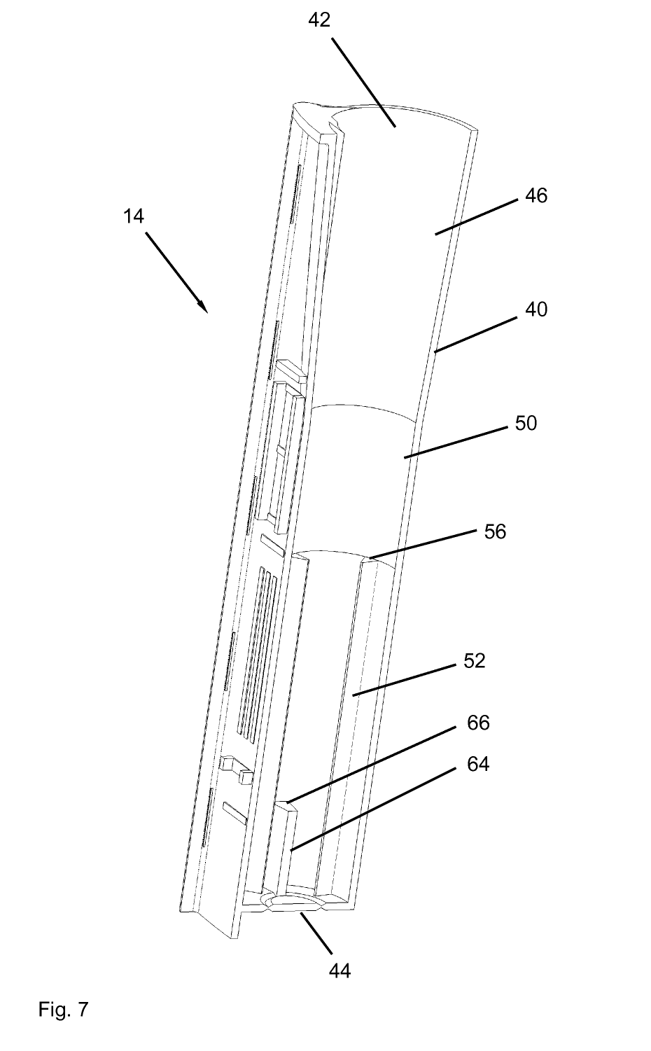

The views in FIG. 7 and in FIG. 8 show the extractor 14 in enlarged form in a longitudinal section and with further details. The extractor 14 is generally an elongated tube 40 and functions as a sample preparation unit. The sample preparation unit designated below just as extractor 14 has an opening 42 on its top side for accommodating the sampler 12 as well as an at first closed interface 44 on its bottom side for combination with the starter 16.

Sampler 12 and extractor 14 combined form the shaking reactor 18 (FIG. 5) and a hermetically sealed chamber in the interior of the shaking reactor 18. The drawing of a liquid sample from the sampler 12, namely from the sampling body 24 of the sampler 12, or the separation and dissolution of particulate substances from the sampling body 24 takes place in this chamber by means of a shaking process. The shaking reactor 18 can then be opened by means of the starter 16, so that the respective reaction mixture can be discharged and be fed to a test strip 72, which is not shown separately and is known per se (FIG. 12).

The tube 40, which is open on one side, of the extractor 14 is designed as an insertion area 46 for the sampler 12 on its open side. In this case, the tube 40 has on its inner surface smooth walls as well as (not shown here) snapping or locking contours for the positive-locking and locked mounting of the sampler 12, for example, by meshing with its groove 30 (FIG. 6). A strictly cylindrical pressure build-up zone 50 is located approximately in the middle of the extractor 14. The diameter of the pressure build-up zone 50 corresponds to the diameter of the sealing lip 28 (FIG. 6) of the sampler 12. In this area, the sealing lip 28 of the sampler 12 slides over the inner surface of the pressure build-up zone 50 in order to generate tightness, on the one hand, and on the other hand, a defined overpressure in the shaking reactor 18. The overpressure results from the compressed air volume when pushing together the sampler 12 and the extractor 14. The maximum height of the overpressure is defined by the longitudinal extension of the pressure build-up zone 50.

In the bottom area, the extractor 14 has the interface 44, which has already been mentioned and which also functions as a breaking point, for combining with the starter 16, which interface 44 can be penetrated only when interacting with the starter 16. The bottom of the extractor 14 is liquid-tight in the undamaged state and resistant to overpressure within certain limits.

Holding ribs 52 are located on the tube wall 40 for elastic clamping of an optional liquid reagent depot 54 (FIG. 8). The holding ribs 52 make possible, on the one hand, the fixing of the liquid reagent depot 54, but, on the other hand, are not raised so far over the inner surface of the tube wall 40 that the insertion of the sampling body 24 would be hindered. The holding ribs 52 form optionally a contact surface 56 for reagent carrier 58 (FIG. 8) and/or process indicators in the direction of the upper opening 42. The contact surface 46 may also be formed in a different form, for example, in the form of a step in the inner contour of the tube wall 40.

An additional or alternative reagent carrier 60 (FIG. 12), and especially a microporous reagent carrier functioning as a dry reagent depot, which preferably consists of a sintered plastic, may optionally be located on the bottom of the extractor 14. The reagent carrier 58, 60 shown in FIG. 8 and FIG. 12 show possible positions of such reagent carriers 58, 60. Basically, one or more reagent carriers may also be located at other sites in the interior of the shaking reactor 18, for example, also in the form of looser reagent carriers 58, 60, as this is shown in FIG. 1 for the loose display element 2 there.

The or each reagent carrier 58, 60 is at first wetted during the shaking process when the shaking reactor 18 is shaken, and then the respective reagent is gradually dissolved by further shaking The arrangement of a reagent carrier 58, 60 above and/or below the sampling body 24 inserted into the extractor 14 guarantees that the flowing around and wetting resulting during the shaking concerns the sampling body 24 and the or each reagent carrier 58, 60 equally, such that a discoloration of the or each reagent carrier 58, 60 also indicates a sufficient separation of the sample from the sampling body 24.

A circumferential gap 62 (FIG. 12) between the sampling body 24 and the tube wall 40 determines the extraction efficiency due to shaking if using low liquid reagent volumes (liquid reagent quantity in the liquid reagent depot 54) between 0.2 mL and 0.6 mL. The ratio of liquid reagent volume to the volume of the reaction mixture is typically between 1.5:1 and 3:1. Circumferential gaps 62 with a width of 0.5 mm to 3.0 mm have proven to be especially favorable in terms of a shortened shaking time for the complete mixing of the sample.

In a special embodiment of the test kit 10, the or each reagent carrier 58, 60 is present as a sintered body, wherein the carrier material is microporous. In case of a colored dry reagent, the or each reagent carrier 58, 60 also functions as a shaking indicator and with decreasing pore size of the carrier material, the process of eliminating a colored dry agent can be specifically slowed down as needed in order to guarantee the complete mixing of the sample with the reagent during the discoloration of the shaking indicator. Thus, the or each reagent carrier 58, 60 of the test kit 10 also functionally corresponds to the display element 2 of the testing device 10 and is an example of such a display element 2. In a special embodiment of the test kit 10, the indicator dye of the respective reagent carrier 58, 60 is at the same time a color reagent with reporter function within the framework of an immunoassay for drug substances.

The process of manual shaking of the shaking reactor 18 ends with complete discoloration of the indicator component of the shaking indicator of the or each reagent carrier 58, 60. The indicator response characteristic in a reagent carrier 58 that is located above the sampling body 24 behaves proportionally to the shaking intensity and shaking frequency in vertical orientation and therefore is dependent on the shaking mode of the individual user. The time of the discoloration ensures that the sample in the sampling body 24 is also completely mixed with the liquid reagent and the dry reagent. The embodiment of the extractor 14 with a transparent plastic guarantees the easy recognizability of discoloration of the shaking indicator. Accordingly, the extractor 14 having a transparent wall or a wall that is transparent in some sections functionally corresponds, in this respect, to the mixing container 1, which is transparent or transparent in some sections, of the testing device 10.

The holding ribs 52 enclose a conceived cylinder, which has a lower diameter than a liquid reagent depot 54 to be held and a greater diameter compared to the diameter of the sampling body 24. Cracking ribs 64, whose end faces 66 function as stop/contact surface for a liquid reagent depot 54, project upward from the bottom of the extractor 14. The cracking ribs 64 correspondingly enclose a cylindrical region with a smaller diameter compared to the cylindrical region enclosed by the holding ribs 52.

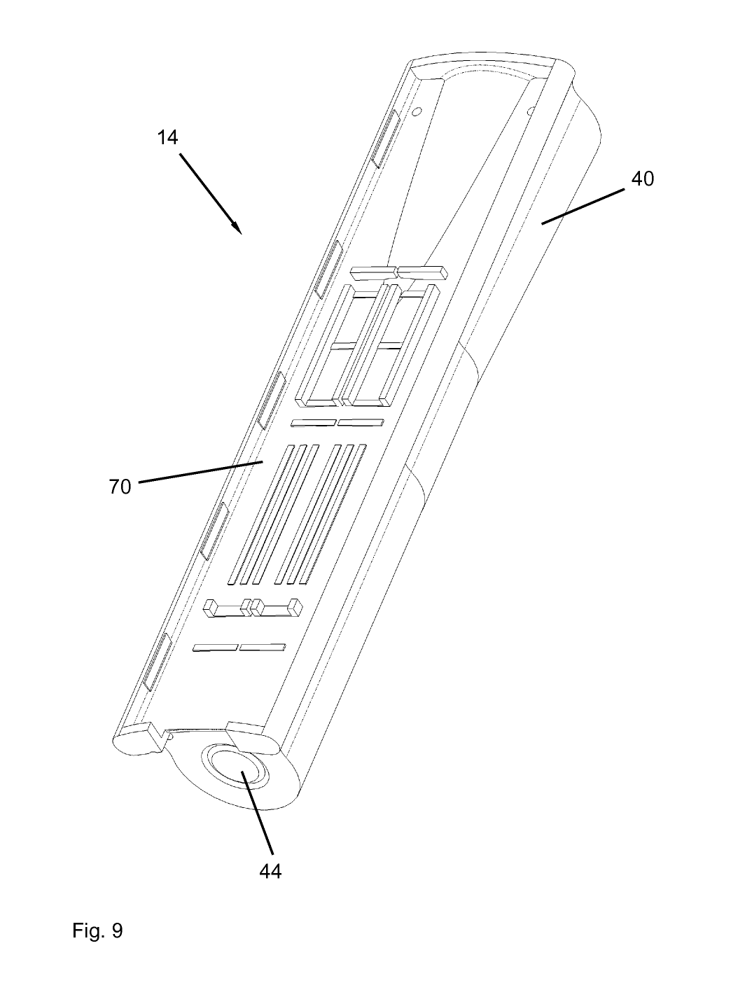

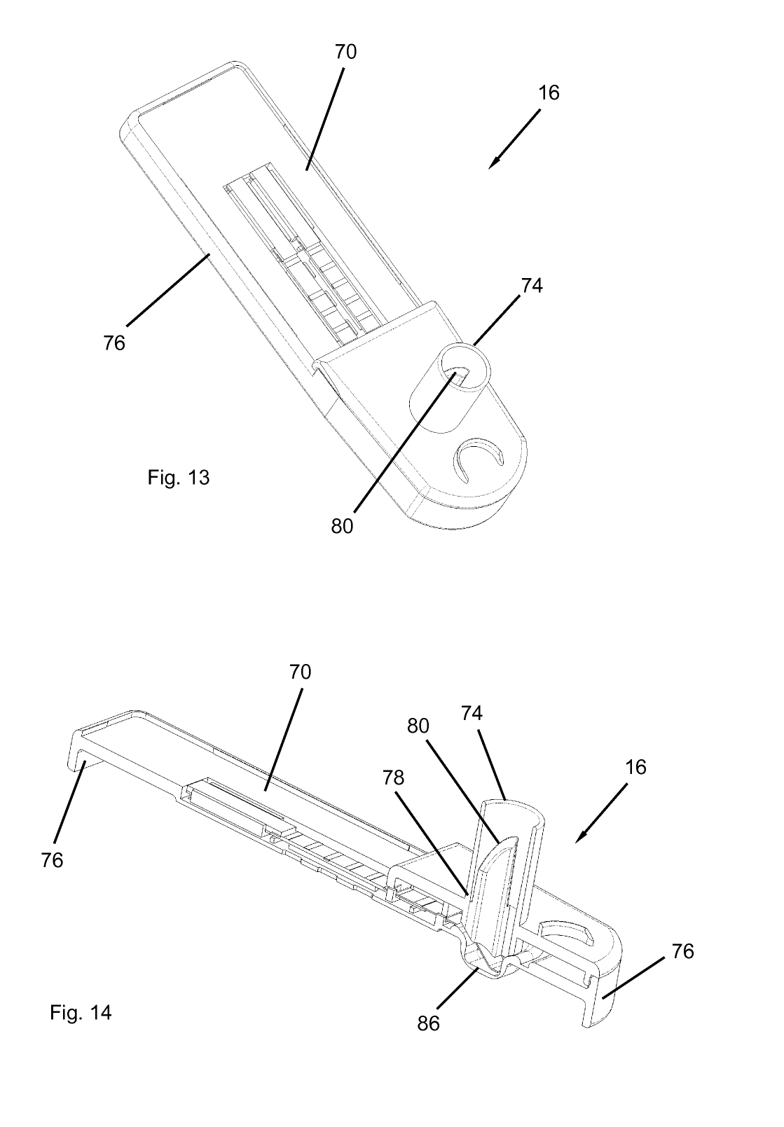

A test strip platform 70, which is intended for accommodating immunochromatographic test strips 72, is optionally located on the outer side of the extractor 14. For this, the view in FIG. 9 shows the extractor 14 according to FIG. 7 and FIG. 8 from a different perspective. The test strip platform 70 for fixing immunochromatographic test strips 72 is either a component of the extractor 14 that is spatially insulated from the interior of the tube 40 with vertical orientation or (see FIG. 13, FIG. 14) an element assigned to the starter 16 with horizontal or vertical orientation. At any rate, the respective reaction mixture reaches the test strip platform 7, when the shaking reactor 18 is opened by means of the starter after conclusion of the shaking process and the reaction mixture is discharged from the shaking reactor 18.

### C. Starter 16

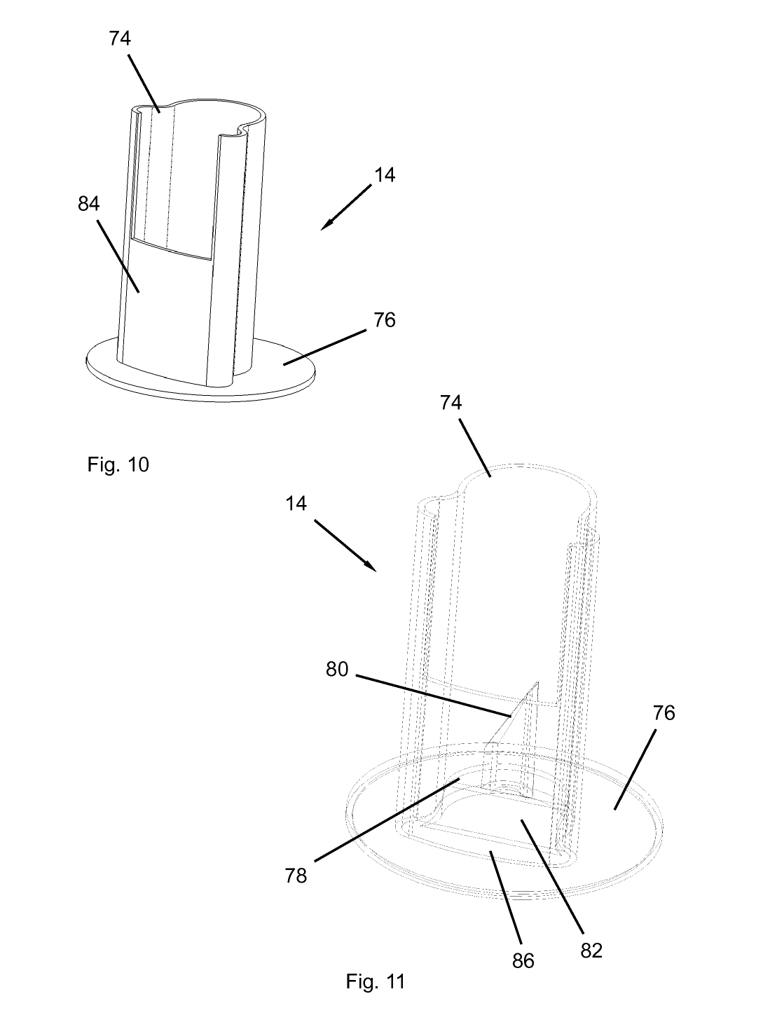

The views in FIG. 10 and FIG. 11 show an embodiment of the starter 16, which is designated below and only for distinction as a standard configuration, in perspective view or in the form of an (enlarged) wire grid model. The standard configuration of the starter 16 combines a guiding profile 74, which is open at the top, provided for accommodating and guiding a lower area of the extractor 14, and a support foot 76 for the vertical alignment of the shaking reactor 18 to be mounted on an even surface. The inner contour of the starter 16 and the guiding profile 74 are embodied in such a way that the extractor 14 can perform a movement directed downwards guided on one side in the starter 16, while an upwards directed movement over barrier contours, for example, similar to the circumferential groove or bead 30 on the sampler 12 is optionally made more difficult.

A stop for the bottom side of the extractor 14 is formed in a bottom area of the starter 16 and a penetration profile 80, which penetrates the breaking point 44 of the shaking reactor 18 when a force is applied, rises up there to open the chamber formed in the shaking reactor 18. The fluid transfer of the reaction mixture located in the chamber to the test strip platform 70 is guaranteed by the overpressure obtained when combining the sampler 12 and the extractor 14. Under the stop 78, a drain 82 (see also FIG. 12), the support foot 76 and a front wall 84 of the starter 16 form a catch basin 86 for the reaction mixture being discharged from the shaking reactor 18. Into this catch basin 86 drains the reaction mixture in a preferred position of the test kit 10 mounted on a stop surface and secured by the overpressure in the shaking reactor 18. At least one immunochromatographic test strip 72, which absorbs the reaction mixture in a capillary active manner and feeds it to an immunochemical reporter reaction, dips into the catch basin 86.

The view in FIG. 12 shows the test kit 10 with the shaking reactor 18 into the starter 16. The reaction mixture, because of the overpressure prevailing in the shaking reactor 18 from the catch basin 86, reaches the test strip platform 70 at the extractor 14 and the or each test strip 72 attached there.

The views in FIG. 13 and FIG. 14 show in a perspective view and in a longitudinal sectional view, respectively, another embodiment of the starter 16, in which this has a test strip platform 70 for test strips 72. In this embodiment, because of the overpressure prevailing in the shaking reactor 18 from the catch basin 86 (FIG. 14), the reaction mixture reaches the test strip platform 70 of the starter 16 and the or each horizontally mounted test strip 72 attached there.

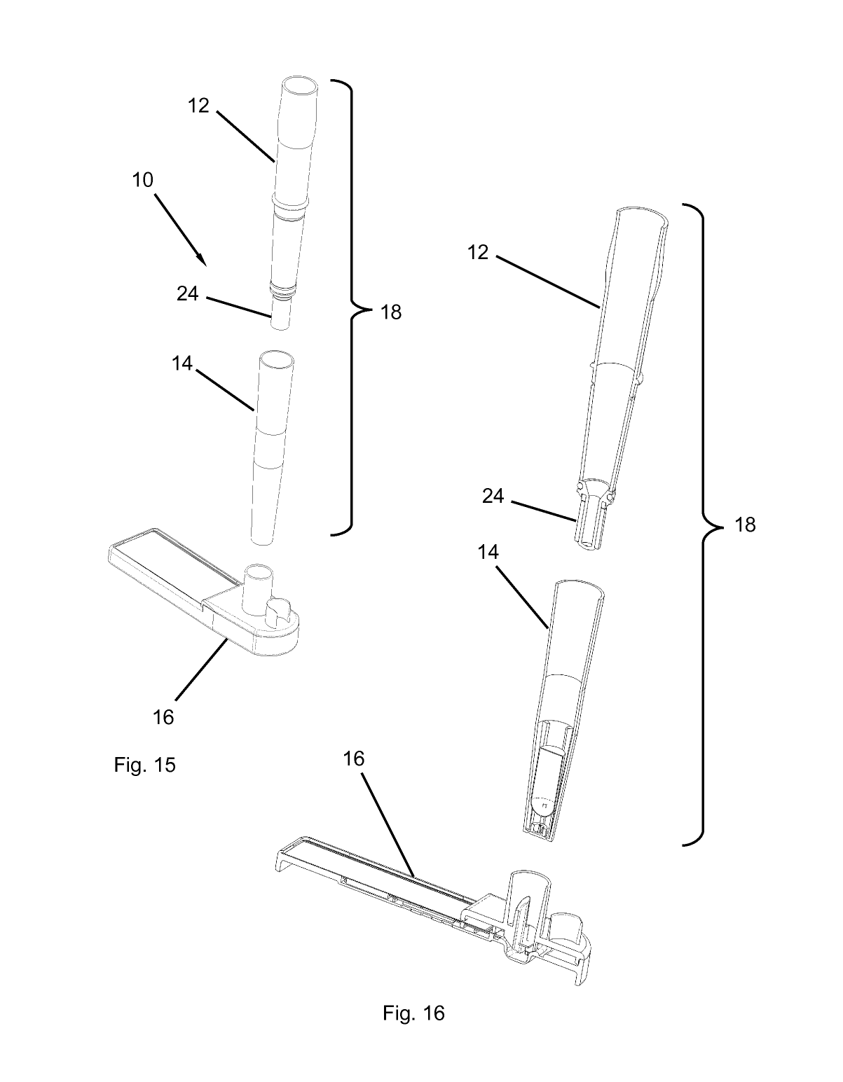

The views in FIG. 15 and FIG. 16 show in a perspective view and in a longitudinal sectional view, respectively, the test kit 10 before combining the sampler 12 and the extractor 14 into the shaking reactor 18 and before inserting the shaking reactor 18 into the starter 16, wherein the combining of sampler 12 and extractor 14 may also take place when the extractor 14 is already inserted into the starter 16. In order to not make the overview of the views unnecessarily more difficult, a repetition of individual reference numbers has been dispensed with. Reference is made to the previous figures in this respect.

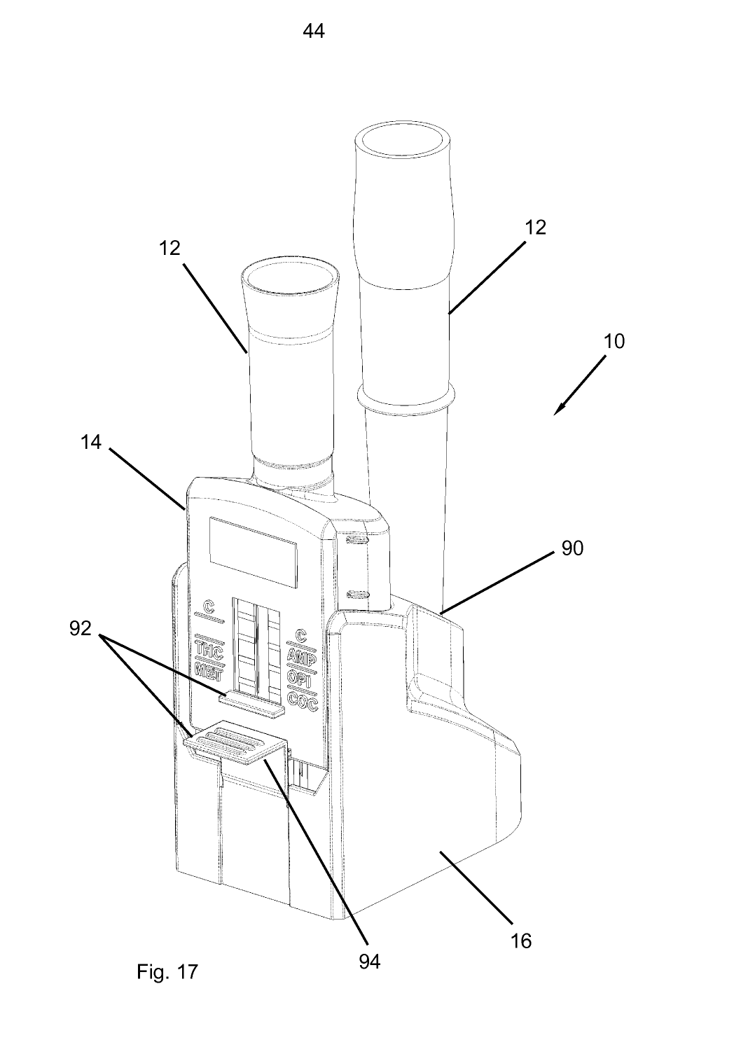

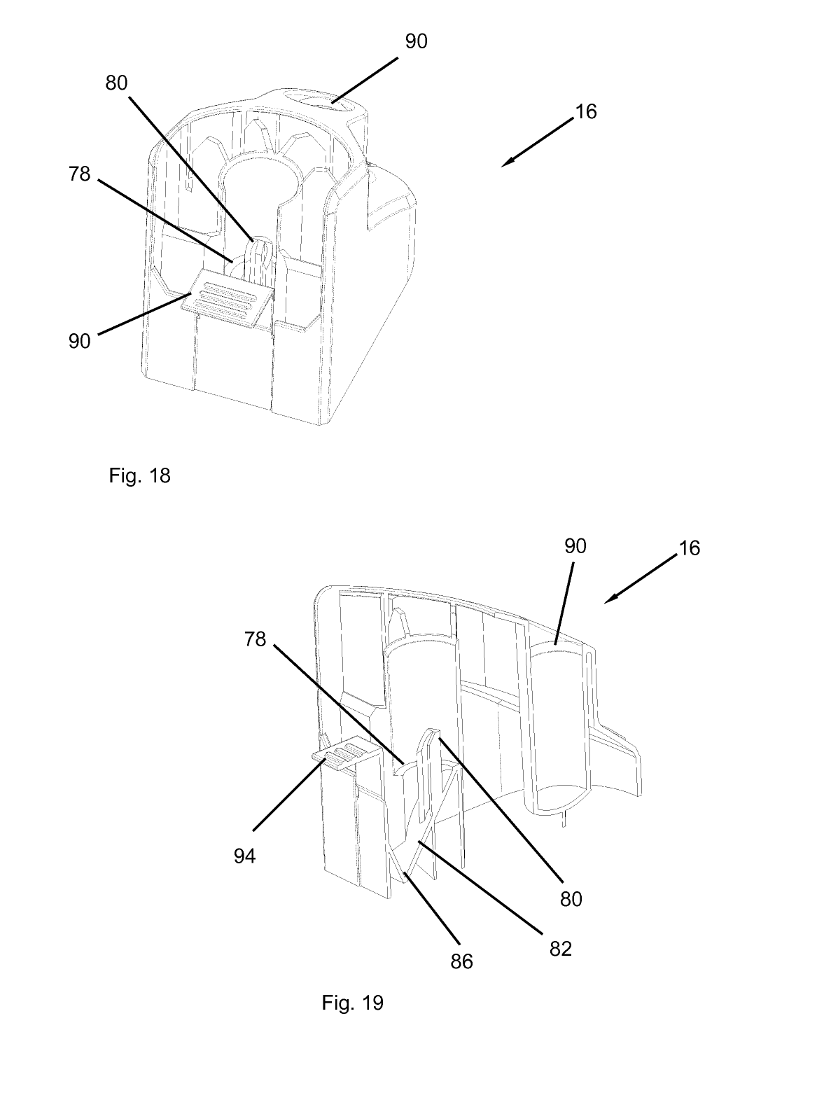

The view in FIG. 17 shows the test kit 10 with another embodiment of the starter 16. The views in FIG. 18 and FIG. 19 show the starter 16 from FIG. 17 in different and partly cutaway views. According to these views the starter 16 may have a hygienic storage 90 in the form of a blind hole for storing the sampler 12. The hygienic storage 90 is suitably dimensioned, such that a sampler 12 inserted there before its use is protected all around against environmental effects. The sealing lip 28 of the sampler 12 insulates the sampler 12 within the hygienic storage 90.

In addition or as an alternative to the hygienic storage 90, the starter 16 may have a early-start securing device 92 in the form of a removable strap 94 or the like. In the embodiment shown, this early-start securing device 92 is designed as a graspable and movable projection, which is connected to the starter 16, for example, via a thin film hinge. Such an early-start securing device 92 or a similar physical block forms a stop for the extractor 14, when this is located connected with the starter 16 and the sampler 12 is combined with the extractor 14 when a force is applied. In this case, the inadvertent opening of the extractor 14 by the starter 16 is prevented by the early-start securing device 92. Only if the strap 94 is manually removed, i.e., for example, snapped off, can the shaking reactor 18 be pressed into the starter 16 up to the stop 78.

In case of a use of the sampler 12 for taking up a saliva sample, the sampler 12 is guided into the mouth by the test subject and is then brought to various positions in the oral cavity, for example, the cheek pouches or in the area of the tongue. The saliva collected with the sampler 12 is then located, because of the surface contact with the mucous membrane of the mouth, on the surface or in the pores of the capillary active sampling body 24. A complete or sufficient filling of the sampling body 24 is indicated by the indicator ring 36 with complete discoloration or flushing out of the deposited food-compatible dye.

In a use of the sampler 12 for taking up very fine solid particles or dust particles, the sampling takes place by pressing on or unrolling the sampling body 24 on an object or on a surface. The surface may be dry or wet. The free rotatability of the sampling body 24 over the mounting pin 22 of the sampler 12 facilitates the adherence or absorption of particles in the course of a rotating movement. Such a sampling comes into consideration, for example, for the forensic detection of drugs in their commercial form. Pieces of clothing or objects that might have come into contact with the drugs, for example, are examined in this case, by their being rubbed with the sampling body 24 or by the sampling body 24 of the sampler 12 being unrolled on the object.

D. Sample Preparation using the Example of a Saliva Sample

For the analysis of a saliva sample, the sampler 12 is inserted into the extractor 14 manually in connection with the sampling. The process of fitting together these two components 12, 14 takes place in a position-independent manner with a manual application of force. The handling of the extractor 14 may take place in this case independently of the starter 16 or in a configuration of a held connection with the starter 16. The open tube end 42 of the extractor 14 and the circumferential border 26 on the sampler 12 function as a stop for the sampler 12 when inserting the sampler 12. The sampler 12 seals the cylindrical area of the extractor 14 functioning as a pressure build-up zone 50 via the ring-shaped circumferential sealing lip 28. A corresponding, not shown here, snap contour of the extractor 14 snaps in a positive-locking manner into a snap contour of the sampler 12 in the form of or in the manner of the circumferential groove 30 and functions as a sealing device. In this first handling step of the sample preparation in the form of inserting the sampler 12 into the extractor 14, the spatially defined shaking reactor 18 is formed. In the same work step, a liquid reagent depot 54, for example, a liquid reagent depot 54 in the form of a glass ampule filled with liquid reagent, is opened in a destructive manner by perforation using the perforation tip 34 of the sampler 12.

A subsequent, second handling step comprises the shaking of the shaking reactor 18, especially a shaking of the shaking reactor 18 in the direction of its longitudinal axis. Mixing of the saliva sample collected with the sampler 12 and located on the surface or in the pores of the capillary active sampling body 24 with dry and/or liquid reagents occurs first due to this agitation. The saliva sample as well as the reagent contained in the or each reagent carrier 58, 60, for example, drug-specific antibody-nanogold conjugates, come into contact with the liquid reagent of the liquid reagent depot again and again in the course of the shaking motion. In a glass ampule functioning as a liquid reagent depot 54, small glass splinters, i.e., glass splinters that are smaller than the gap 62 between the sampling body 24 and the opposing inner surface of the tube wall 40 are accelerated more intensely vertically than the liquid in the course of the shaking motion due to their greater own specific weight. The liquid adhering to them facilitates the vertical transfer in the shaking reactor 18. Gradual drawing out of the sample (extraction) and of the dry reagent occurs due to repeated liquid film formation on the sampling body 24 as well as on the or each reagent carrier 58, 60 and followed by drop separation. The shaking process lasts until either the colored reagent carrier 58, 60 becomes discolored or a preset shaking time is reached. However, in order to avoid the uncertainty of the execution of a shaking process by various individuals, provisions are made for the discoloration of the or each reagent carrier 58, 60 to function as an indicator for a sufficient shaking process and interindividual differences during the shaking can consequently be compensated.

The sample preparation ends with the conclusion of the described shaking process and an optionally subsequent incubation phase, while the shaking reactor 18 remains in a resting position for a defined time before the fluid transfer to one or more test strips 72 is triggered. If the shaking reactor 18 is not already located in the starter 16 during the shaking process, it is now inserted into the starter 16. At any rate, after conclusion of the shaking process, the shaking reactor 18 is pushed through into the starter 16 up to the stop 78, wherein the starter 16 is arranged on a surface for this. Before the pushing through of the shaking reactor 18 into the starter 16, a bending off, tearing off or other removal of the strap 94, which prevented the penetration of the penetration profile 80 into the breaking point 44 when combining the sampler 12 and the extractor 14 in the starter 16, may possibly take place. With the pushing through of the shaking reactor 18 into the starter 16, the penetration profile 18 opens the breaking point 44 at the bottom of the extractor 14 and the reaction mixture located in the shaking reactor 18 is discharged downward with a sudden loss of pressure. In this third work step, the transition of the reaction mixture, consisting of a homogeneous mixture of saliva, liquid reagent and antibody-nanogold conjugate, passes to the test strip platform 70. A test strip 72 located there absorbs or a plurality of test strips 72 located there absorb the mixture from the catch basin 86 partly due to capillary forces autonomously.

After the mixture has run over the test strips 72 within a few minutes, test lines visible in color, which can be analyzed within the scope of a visual interpretation, have developed depending on the analyte concentration and on an immunochemical trapping reaction accompanied thereby.

While specific embodiments of the invention have been shown and described in detail to illustrate the application of the principles of the invention, it will be understood that the invention may be embodied otherwise without departing from such principles.

### APPENDIX

### LIST OF REFERENCE NUMBERS

1 Mixing container
2 Display element
3 Cover
4 Liquid sample and/or dilution fluid
5 Solid sample
6 Outlet
10 Testing device/test kit
12 Sampler
14 Extractor
16 Starter
18 Shaking reactor (mixing container)
20 Handle
22 Mounting pin
24 Sampling body
26 Circumferential border
28 Circumferential sealing lip
30 Circumferential groove or bead
32 Position-securing contour
34 Perforation tip
36 Indicator ring
40 Tube/tube wall
42 Upper opening of the extractor/tube end
44 Interface functioning as breaking point at the bottom of the extractor
46 Insertion area (for the sampler)
48 - - -
50 Pressure build-up zone
52 Holding rib
54 Liquid reagent depot
56 Contact surface
58 Reagent carrier
60 Reagent carrier
62 Circumferential gap
64 Cracking rib
66 End face (of a cracking rib)
68 - - -
70 Test strip platform
72 Test strip
74 Guiding profile (in the starter; for accommodating the extractor)
76 Support foot (of the starter)
78 Stop (in the starter)
80 Penetration profile
82 Drain
84 Front wall (of the starter)
86 Catch basin
88 - - -
90 Hygienic storage
92 Early-start securing device
94 Strap (of the early-start securing device)

What is claimed is:

1. A testing device comprising:
a mixing container; and
a display element located in the interior of the mixing container, the display element comprising a shaking indicator providing a visual indication that the container has been subjected to shaking for a necessary or sufficient duration.

2. A testing device in accordance with claim 1, wherein:
the mixing container is transparent in at least some transparent sections; and
the display element is arranged relative to the transparent sections to be visible from outside of the mixing container.

3. A testing device in accordance with claim 1, wherein the mixing container comprises:
a sampler;
an extractor; and
a starter, wherein with the sampler combined with the extractor, the extractor combined with the starter the mixing container is sealed and a functioning shaking reactor is formed.

4. A testing device in accordance with claim 3, wherein:
the sampler comprises a sampling body at one end;
the sampler is insertable along with the sampling body into a tube of the extractor;
an overpressure forms in the interior of the thus formed shaking reactor during the insertion of the sampler into the extractor.

5. A testing device in accordance with claim 4, wherein the overpressure forms in the interior of the shaking reactor by the extractor having a section with a strictly cylindrical pressure build-up zone and the sampler having a circumferential sealing lip, which comes into contact with the inner surface of the pressure build-up zone during the insertion of the sampler into the extractor.

6. A testing device in accordance with claim 3, wherein:
the starter comprises a penetration profile at the bottom of the starter;
the extractor comprises a breaking interface forming a breaking point at an extractor bottom; and
the penetration profile opens the extractor bottom during insertion of the extractor into the starter.

7. A testing device in accordance with claim 3, further comprising an early-start securing device comprising a blocking element at the extractor and a blocking element at the starter, which engage to secure against an early start of a full connection of the extractor and the starter.

8. A testing device in accordance with claim 3, further comprising a liquid reagent depot, wherein holding ribs fix the liquid reagent depot in the interior of the extractor.

9. A testing device in accordance with claim 3, wherein a hygienic storage, in the form of a blind hole, is formed in the starter for storing the sampler.

10. A method for using a testing device, the method comprising the steps of:
providing a testing device comprising a mixing container and a display element located in the interior of the mixing container, the display element comprising a shaking indicator providing a visual indication that the container has been subjected to shaking for a necessary or sufficient duration;
providing a sample in the mixing container; and
shaking the mixing container, with the sample provided in the mixing container, until the visual indication of the display element located in the mixing container occurs.

11. A method in accordance with claim 10, wherein the visual indication comprises a discoloration of a display element.

12. A method in accordance with claim 10, wherein:
the mixing container is transparent in at least some transparent sections; and
the display element is arranged relative to the transparent sections to be visible from outside of the mixing container.

13. A method in accordance with claim 11, wherein:
the mixing container comprises a sampler, an extractor and a starter, wherein with the sampler combined with the extractor, the extractor combined with the starter the mixing container is sealed and a functioning shaking reactor is formed;
a sample is taken with the sampler;
the sampler is combined with the extractor, after the sample is taken with the sampler, to form a shaking reactor;
the shaking reactor is shaken until discoloration of the display element occurs; and
an overpressure is generated by combining the sampler and the extractor whereby a resulting sample mixture flows out of the shaking reactor upon opening the shaking reactor.

14. A method in accordance with claim 13, wherein:
the sampler comprises a sampling body at one end;
the sampler is insertable along with the sampling body into a tube of the extractor;
an overpressure forms in the interior of the thus formed shaking reactor during the insertion of the sampler into the extractor.

15. A method in accordance with claim 14, wherein the overpressure forms in the interior of the shaking reactor by the extractor having a section with a strictly cylindrical pressure build-up zone and the sampler having a circumferential sealing lip, which comes into contact with the inner surface of the pressure build-up zone during the insertion of the sampler into the extractor.

16. A method in accordance with claim 13, wherein:
the starter comprises a penetration profile at the bottom of the starter;
the extractor comprises a breaking interface forming a breaking point at an extractor bottom; and
the penetration profile opens the extractor bottom during insertion of the extractor into the starter.

17. A method in accordance with claim 13, further comprising an early-start securing device comprising a blocking element at the extractor and a blocking element at the starter, which engage to secure against an early start of a full connection of the extractor and the starter.

18. A method in accordance with claim 13, further comprising a liquid reagent depot, wherein holding ribs fix the liquid reagent depot in the interior of the extractor.

19. A method in accordance with claim 13, wherein a hygienic storage, in the form of a blind hole, is formed in the starter for storing the sampler.

20. A testing device comprising:
a sampler;
an extractor; and
a starter, wherein with the sampler combined with the extractor, the extractor combined with the starter a mixing container is sealed and a functioning shaking reactor is formed.
